(19) United States
(12) Patent Application Publication
(10) Pub. No.: US 2014/0074380 A1
(43) Pub. Date: Mar. 13, 2014

(54) GAS SUBSTITUTION CONTROL SYSTEM AND METHOD FOR BI-FUEL ENGINE

(71) Applicant: Continental Controls Corporation, San Diego, CA (US)

(72) Inventors: C. Ross Fisher, Cardiff, CA (US); George A. Mansfield, San Diego, CA (US); David G. Fisher, Carlsbad, CA (US); Kristian W. Yates, Valley Center, CA (US); Helal Zahir, San Diego, CA (US); Galina Laur, San Diego, CA (US); Hillary H. Grimes, III, San Diego, CA (US)

(73) Assignee: Continental Controls Corporation, San Diego, CA (US)

(21) Appl. No.: 14/019,742

(22) Filed: Sep. 6, 2013

Related U.S. Application Data
(60) Provisional application No. 61/698,385, filed on Sep. 7, 2012.

(51) Int. Cl. F02D 19/08

(52) U.S. Cl. CPC F02D 19/081
USPC 701/104

(57) ABSTRACT

A gas substitution ratio control system varies natural gas flow to a bi-fuel engine based on detected diesel flow to maintain a desired gas substitution ratio (GSR), without any requirement to sense engine load. In other words, GSR is controlled without monitoring engine load level. In one system, an engine is first calibrated to map actual gas and diesel flows to provide the correct GSR for all engine loads. The calibration data is then stored and diesel flow rate is monitored. The current detected diesel flow rate is used to determine the required gas flow rate for correct GSR. Gas flow to the engine is then adjusted to correspond to the required gas flow rate. Other embodiments meter gas to maintain the diesel flow rate at the same minimum level for all loads, or meter gas and diesel fuel flows to match a map of the limiting fuel energy based GSR (gas fuel energy rate/total fuel energy rate) at all loads for each engine model.

### BACKGROUND

1. Field of the Invention

This invention relates generally to bi-fuel engines in which two different fuels are injected into the combustion chamber, for example a gaseous fuel (NG) and a diesel fuel.

2. Related Art

The allowable ratio of gas flow to total fuel flow (gas substitution ratio, GSR) in a bi-fuel or dual fuel engine is largely a function of engine load. At low loads, low diesel flow and low associated combustion temperatures require that gas flow be zero to prevent engine misfiring. As load is increased, gas flow can be correspondingly increased to approximately 70% of total fuel flow at 100% engine load.

In applications where load can be sensed, the GSR is controlled by scheduling NG flow as a function of load to produce the desired GSR. Some prior gas substitution systems (GSSs) employ load sensing and vary the GSR based on detected load. These all must be adaptable to a wide variety of driven equipment loads. Electrical generator loads can be easily sensed using an output wattmeter and pose little problem. However, pumps, compressors, vehicle drives, and the like have no such unambiguous load-indicating parameters; their loads must be inferred from equipment data that is typically complex and unique to their particular model and situation. Of course, output shaft torque is a valid load parameter, but torque sensors are rarely part of original engine equipment and are costly to retrofit.

### SUMMARY

In one aspect, a control system is provided for varying natural gas flow to a bi-fuel engine based on detected diesel flow to maintain a desired gas substitution ratio (GSR), without any requirement to sense engine load. In other words, GSR is controlled independently from load level. In one system, an engine is first calibrated to map actual gas and diesel flows to provide the correct GSR for all engine loads. The calibration data is then stored and diesel flow rate is monitored, with the detected diesel flow rate used to determine the required gas flow rate for correct GSR. Gas flow to the engine is then adjusted to correspond to the required gas flow rate. The gas flow rate continues to be adjusted based on detected diesel flow rates and the table of corresponding gas flow rates.

In another embodiment, a gas flow bias is introduced to momentarily reduce gas flow rate on detection of acceleration in order to avoid engine misfire.

In another embodiment of a GSR control system which does not require measurement of engine load to control GSR, the diesel fuel flow is maintained at the same minimum level for all loads. In other words, if the diesel flow rate changes or reduces, the gas flow rate is reduced to maintain the same diesel fuel flow setpoint.

In another embodiment of a GSR control system, gas and fuel flows are metered to match a map of the limiting fuel energy based GSR (gas fuel energy rate/total fuel energy rate) at all loads for each engine model. The system may also include a gas flow bias based on detected acceleration. This system controls gas flow based on a previously calibrated or average Gas Substitution Ratio versus total fuel energy. Different maps of Btu/hour versus gas substitution ratio may be generated for different engine models. The total Btu/hour is determined based on the Btu/hour equivalent for the detected gas and diesel fuel flows, and the resultant GSR is compared to the detected GSR. The gas flow is then adjusted to correct any variation in the detected GSR from the mapped GSR for the total Btu/hour for that engine model.

In another embodiment of a GSR control system, a fast-response diesel flow meter assembly measures the difference between a supply flow at a flow meter (from the fuel tank) and a return flow at a flow meter (to the fuel tank) to derive injector flows. An intermittent flow signal thus derived can be averaged to provide a diesel flow signal in one of the other disclosed GSR control systems. The average flow sensing response time is on the order of tens of milliseconds, which provides a faster indication of variations in diesel fuel flow.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is a graph illustrating typical gas substitution ratio (GSR) versus load;

FIG. 2 is an example of a graph of an average gas flow versus diesel flow for multiple engine types for use in a gas substitution ratio control system with no load sensing;

FIG. 2A is a graph similar to FIG. 2 determined by calibration of a particular engine model;

FIG. 3 illustrates a first embodiment of a GSR control system;

FIG. 4 illustrates a second embodiment of a GSR control system;

FIG. 5 is a graph illustrating GSR response over time for a step reduction in the driven load using the control system of FIG. 3;

FIG. 6 is a graph illustrating GSR response over time for a step reduction in the driven load using the control system of FIG. 4;

FIG. 7 illustrates a third embodiment of a GSR control system which is a modification of the system of FIG. 4;

FIG. 8 illustrates a fourth embodiment of a GSR control system using a heat rate-based GSR at all loads based on each engine module;

FIG. 9 is an example of a graph of GSR versus fuel input energy rate which may be used in the gas substitution ratio map module of FIG. 8;

FIG. 10 is a block diagram of one embodiment of a unit injector diesel fuel system including a diesel flow meter assembly;

FIGS. 11A-11C illustrate diesel flow waveforms at various points in the system of FIG. 10; and

FIG. 12 is a block diagram illustrating an example of a processor based system that may be used in connection with various embodiments described herein.

### DETAILED DESCRIPTION

Certain embodiments as disclosed herein provide for a system and method for controlling the ratio of gas flow to total fuel flow or the gas substitution ratio (GSR) in a bi-fuel engine independent of any load sensing. Because of the fact that the control of non-generator loads can be difficult without direct torque sensing, any scheme that obviates the need for load sensing altogether is attractive.

After reading this description it will become apparent to one skilled in the art how to implement the invention in various alternative embodiments and alternative applications. However, although various embodiments of the present invention will be described herein, it is understood that these embodiments are presented by way of example only, and not limitation.

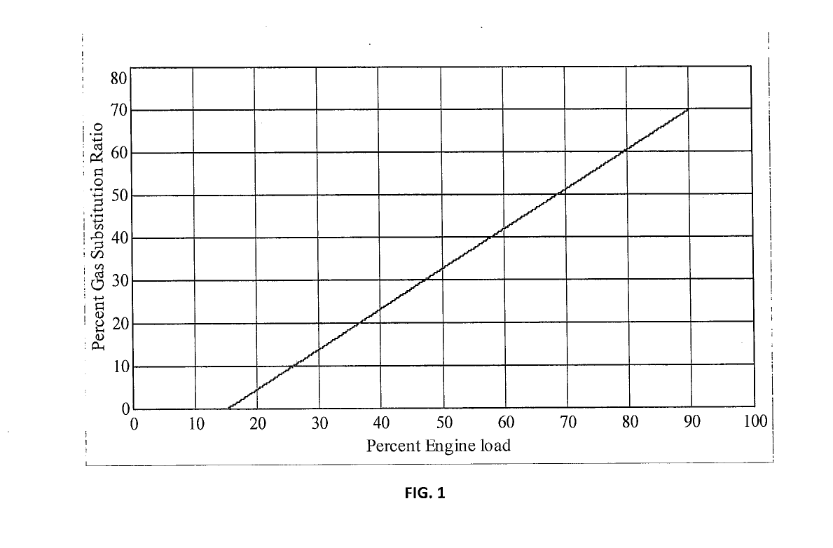

The allowable ratio of gas flow to total fuel flow (gas substitution ratio, GSR) in a bi-fuel or duel fuel engine is largely a function of engine load. At low loads, low diesel or non-gaseous fuel flow and low associated combustion temperatures require that gaseous fuel flow be zero to prevent engine misfiring. As load is increased, gaseous fuel flow can be correspondingly increased to approximately 70% of total fuel flow at 100% engine load. FIG. 1 shows a typical map of GSR as a function of engine load. The two fuels in such engines are typically a non-gaseous fuel such as diesel and a gaseous fuel such as natural gas (NG) or propane.

In applications where load can be sensed, the GSR is controlled by scheduling NG flow as a function of load to produce the GSR specified in FIG. 1. Prior art includes gas substitution systems (GSSs) which employ load sensing. These all must be adaptable to a wide variety of driven equipment loads. Electrical generator loads can be easily sensed using an output wattmeter and pose little problem. However, pumps, compressors, vehicle drives, and the like have no such unambiguous load-indicating parameters; their loads must be inferred from equipment data that is typically complex and unique to their particular model and situation. Of course, output shaft torque is a valid load parameter, but torque sensors are rarely part of original engine equipment and are costly to retrofit.

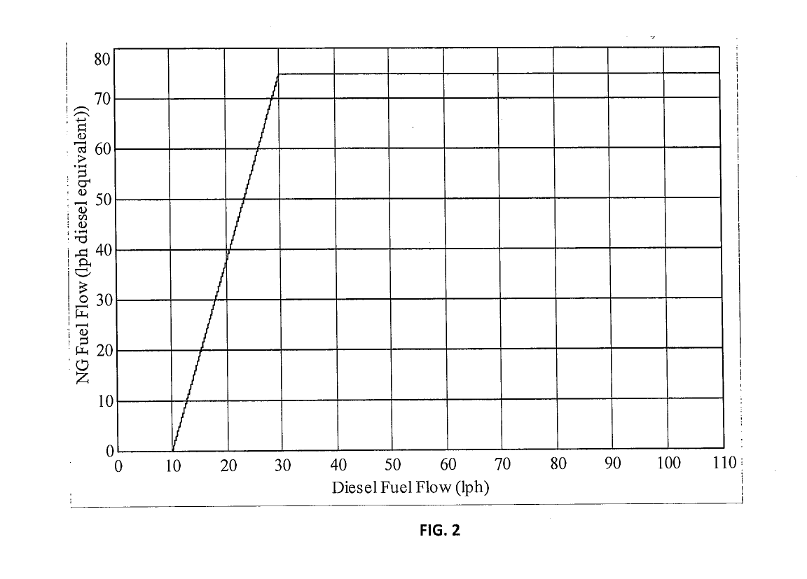

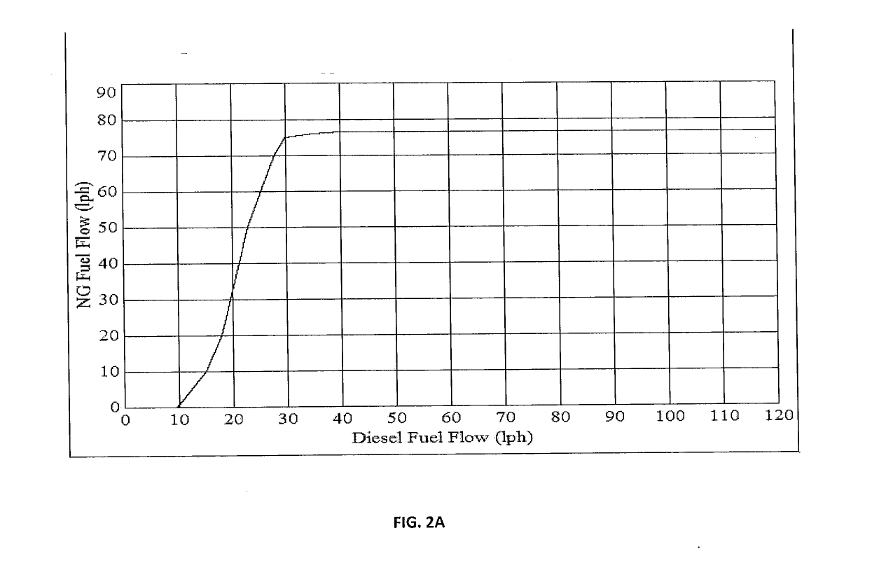

For steady state operation (where load is changing only very slowly), load need not be sensed. In one embodiment, the proper GSR is controlled by sensing DF flow and metering NG flow to match the schedule of FIG. 2, which shows average diesel and gas flow values for different engines. These values are obtained by first calibrating an engine at various loads. Once a particular engine has been calibrated, the same schedule of diesel and gas flow can be used for all engines of that type. FIG. 2A illustrates diesel and gas flow rates determined for a specific engine type, specifically a Detroit Diesel Series 60 engine, rated at 380 HP. FIG. 3 is a block diagram of one system for controlling GSR using detected diesel or non-gaseous fuel flow, and using the previously calibrated schedule of FIG. 2 or FIG. 2A to vary natural gas or gaseous fuel flow based on the detected diesel flow. In one embodiment, non-gaseous fuel flow may be detected by reading the fuel flow parameter from the electronic control unit (ECU) of the engine.

The system of FIG. 3 includes engine 10 which has a variable driven load 11. Diesel and gas fuel are supplied to engine 10 via diesel injectors 15 and gas metering assembly 25. A diesel fuel speed governor 12 is connected to a speed command input 14, and controls diesel fuel injectors 15 which provide diesel flow 16 as a component of the total gas flow 17. A speed sensor 18 detects engine speed 20 and provides speed feedback 21 to speed governor 12, which controls injectors 15 based on difference between the current speed command 14 and the actual speed feedback 21. A diesel (DF) flowmeter 22 detects diesel flow 16 to the engine and is connected to a natural gas (NG) scheduler 24 and natural gas (NG) metering assembly 25 which provides controlled gas flow input 26 to the total gas flow 17. The natural gas scheduler includes stored calibration data corresponding to FIG. 2 and selects the appropriate gas flow based on the detected diesel flow, then controls the natural gas metering assembly to provide the selected gas flow 26 to the engine. The diesel flow and gas flow are combined at 28 to provide total fuel flow 17. Gaseous fuel flow to the engine may be adjusted by controlling gaseous fuel pressure to the engine.

When loads are changing rapidly, the system of FIG. 3 maintains accurate control of GSR only if the DF flowmeter and NG metering assembly both have virtually instantaneous response, a practical impossibility. In the situation where load is suddenly increased, the DF governor responds to decreasing speed by increasing DF flow. Any lag in the DF flowmeter or NG metering assembly causes an under fuel condition for NG flow until steady state conditions are reestablished at the higher load. This poses no problem because the DF governor 12 supplies the necessary transient fuel correction and the momentary NG under fueling results in GSR being less than prescribed misfire levels.

On the other hand, when load is suddenly reduced, an NG over fuel and resultant engine misfire condition can occur. Engine speed increases with a decreased load until the governor reduces DF flow to the level required by the reduced load. However, the NG metering system responds to the DF flowmeter, whose delayed signal is still requesting a high NG flow. During this load transient, the actual DF flow is low but NG flow is incorrectly high, producing an actual GSR that is too high, and engine misfires may then occur.

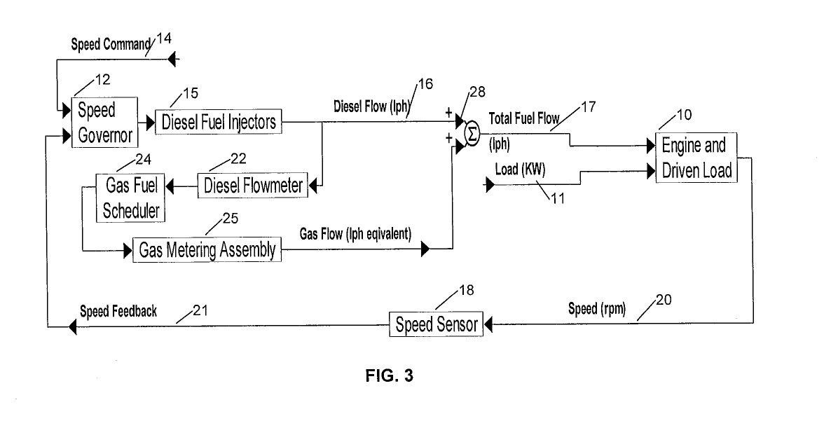

FIG. 4 shows a modification of the system of FIG. 3 to reduce or eliminate engine misfires. It is based on scheduling NG flow as a function of sensed DF flow (as in FIG. 3), and like reference numbers are used for like parts as appropriate, but has an added unique scheme for preventing NG overfuel following rapid load reductions. Here when load is reduced, the gas metering system 30, using a speed derivative sensor or speed differentiator module 32, senses the increasing rate of speed change (acceleration) to command a proportional reduction in NG flow command. The output of speed derivative or acceleration sensor 32 is connected to a positive only limiter module 34, so that the gas flow is only modified in the case of acceleration and not deceleration. Gain adjustment 35 supplies a selected multiplier for scaling the detected acceleration depending on the desired reduction in gas flow percentage at acceleration levels corresponding to decreases in engine load which might result in engine misfire. Gain adjustment 35 has a selected default multiplier value based on the engine type, but can be varied by the user within an allowed range. Finally, a gas flow bias module 36 produces a gas flow bias output for all positive acceleration levels based on the output of the positive only limiter module 34 and the gain adjustment 35. This gas flow bias is input to gas flow adjuster or comparator module 37 and is subtracted from the current gas flow from gas flow scheduler 24 to reduce the gas flow by a bias amount dependent on the detected acceleration and selected gain amount. This reducing NG flow command momentarily overcomes the incorrectly high NG flow command from the slow responding DF flowmeter or electronic control unit (ECU) flow signal. With simple tuning for each specific engine type, the speed derivative sensor 32 can reduce NG flow as fast or faster than the actual DF flow which is being controlled by the speed governor, so that GSR is at or below any prescribed misfire levels for any “off-load” transients.

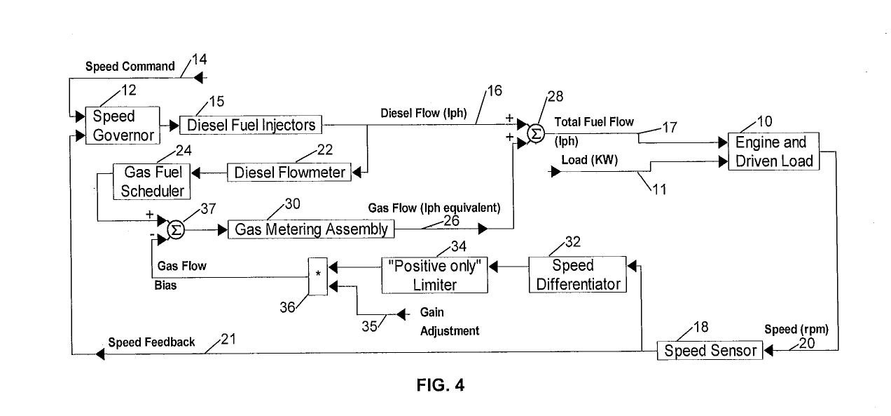

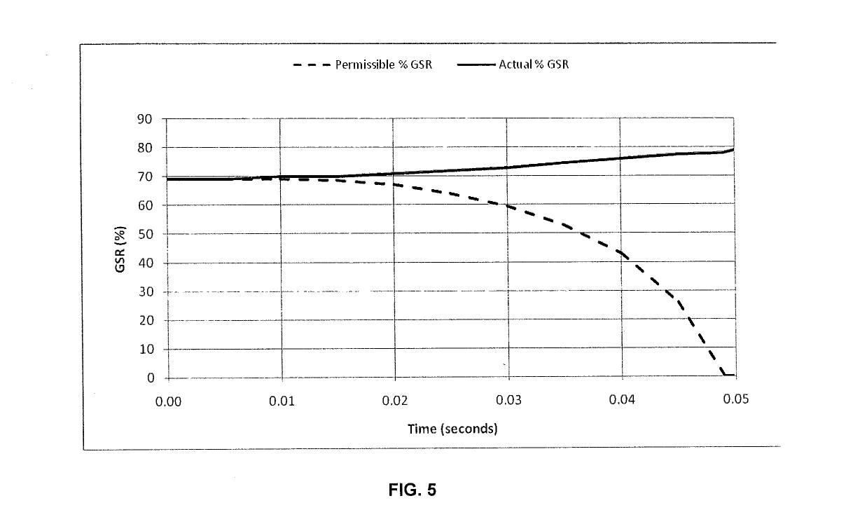

FIG. 5 illustrates typical transient GSR response of the gas substitution control system of FIG. 3 for a step reduction in driven load. As illustrated, the actual GSR (solid line) increases above the permissible GSR in the case of a sudden reduction in load. FIG. 6 illustrates the transient GSR for a sudden reduction in driven load with the gas substitution control system of FIG. 4 with speed derivative NG flow modulation. As indicated, the actual percent GSR remains within permissible levels when the system of FIG. 4 is used for GSR control.

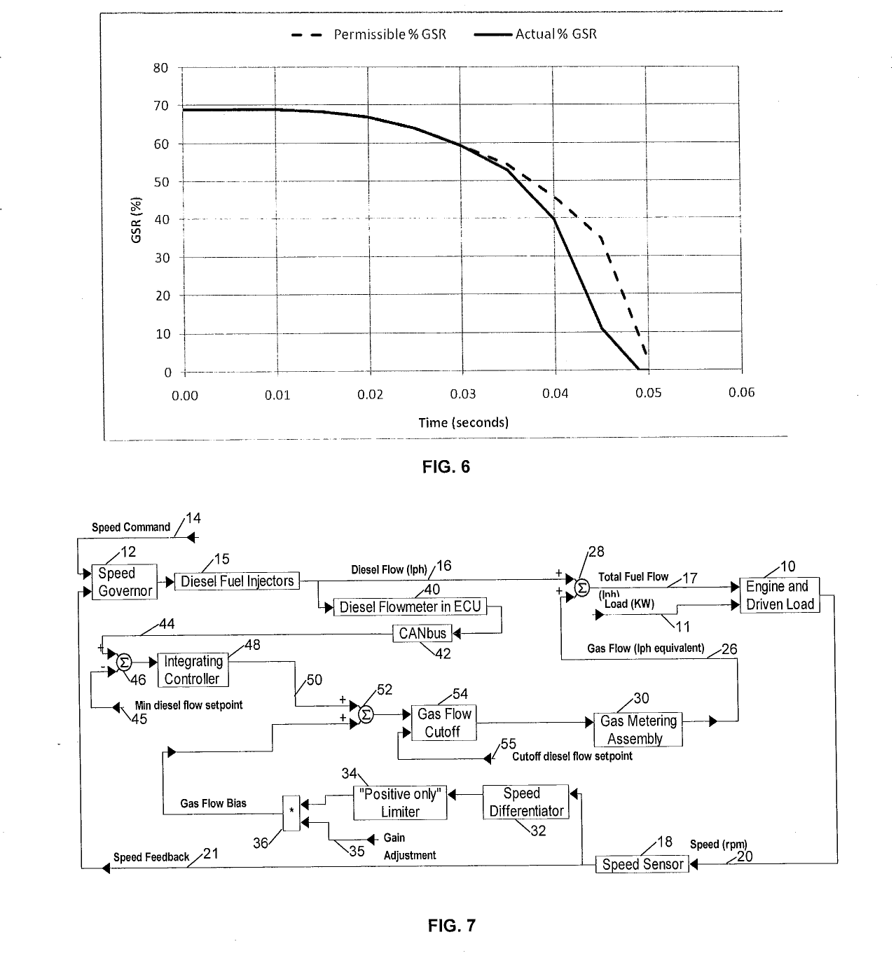

FIG. 7 illustrates another embodiment of a gas substitution control system which provides gas substitution based on a minimum diesel flow setpoint to provide the same diesel flow rate for all loads without the need for a mapping of gas flow to measured load. This system is simpler than the previous embodiments since it simply reduces gas flow as the load is reduced (and thus diesel flow is reduced) so as to maintain the diesel flow rate setpoint at all loads. The diesel governor still has the authority to reduce the diesel fuel flow below the setpoint to maintain engine speed at low loads. The concept is based on controlling gas flow such that diesel fuel flow rate is always maintained at the level (Wd, setpoint) existing at full load with maximum GSR, (typically 30% diesel and 70% natural gas). The minimum diesel flow setpoint is determined by running the engine at full load and increasing gas level until a misfire is detected, and then selecting a minimum diesel flow level which is slightly above the level at which the misfire took place. The control system is configured to maintain the same minimum diesel flow level at all engine load levels by detecting current diesel flow rate and adjusting gas flow appropriately, to achieve the predetermined diesel flow setpoint. As the engine 10 is unloaded and the governor 12 requests less diesel flow, the gas flow controller cuts back its output, to maintain diesel flow rate at “Wd, setpoint”. The result of this action is to maintain the diesel flow rate and reduce GSR as load is reduced, which is the main goal of current load sensing systems, without the requirement for load sensing. Some features of the systems of FIGS. 3 and 4 are included in the embodiment of FIG. 7, and like reference numbers are used for like parts as appropriate. This system includes the speed differentiating feature of FIG. 4 to prevent rich misfire when the load is suddenly reduced, but this may be excluded in alternative embodiments.

The system of FIG. 7 includes a diesel flowmeter 40 in the engine control unit (ECU) with an output via CAN bus 42 providing sampled diesel flow signal 44. This signal is based on a computer calculated diesel flow, which is computed in the ECU. The diesel flowmeter 40 may be replaced by a conventional liquid flow meter. The diesel flow signal 44 is compared to the previously determined minimum diesel flow set point 45 in comparator 46 having an output to integrating controller or integrating module 48. Integrating module 48 is programmed to adjust the gas flow rate, thereby causing diesel fuel flow to return to the minimum diesel flow set point, and produces a corresponding gas flow command signal 50 at its output. If for example, the minimum diesel flow set point is 28 lph, and the measured diesel flow signal is 20 lph, the integrating module will determine how much the gas flow rate needs to be decreased in order to return diesel fuel flow to the 28 lph setpoint. This amount is further modified by gas flow bias 36 if a predetermined level of acceleration is detected at speed differentiator 32, as described above in connection with FIG. 4. The output of controller 48 is a basic gas flow command 50 and is summed with gas flow bias 36 in summer 52 to provide a gas flow command output. Since the acceleration detection is typically faster than the detection of diesel flow rate changes, inclusion of a gas flow bias based on acceleration reduces the risk of engine misfire.

An added feature in this system is the absolute shutoff of gas flow at a cut off diesel flow setpoint 55 whenever diesel flow drops below the minimum idle flow setting, which is typically 45-50% of “Wd, setpoint”. Whenever the gas flow output of summer 52 is detected to correspond to a diesel flow below the cut off diesel flow setpoint 55 in gas flow cutoff control module 54, an output to gas flow cutoff controller provides a zero output to gas metering assembly 30, cutting off the gas flow with a corresponding increase in diesel flow. When the gas flow output is above the cut off diesel flow set point, the output is provided to gas metering assembly 30 to control gas flow to the engine 10.

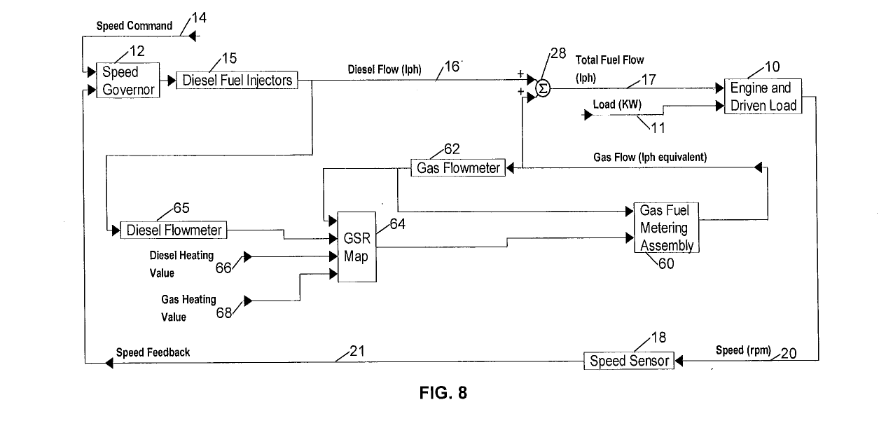

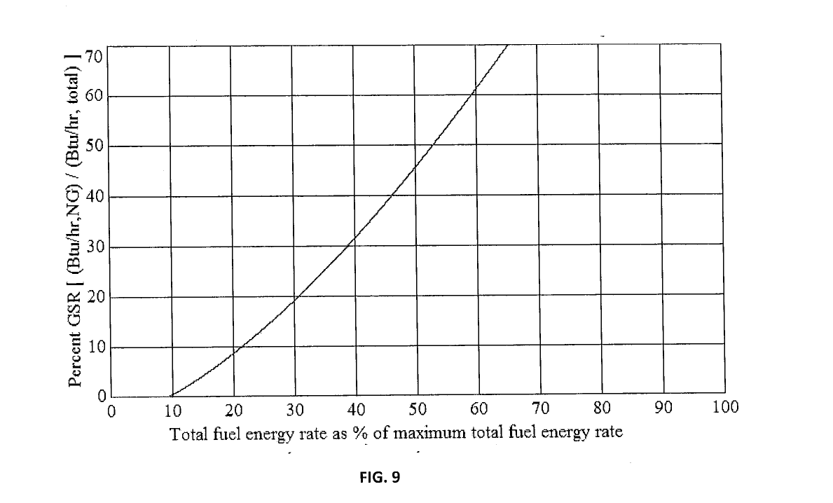

FIG. 8 illustrates another embodiment of a gas substitution control system which uses another method for efficient operation at all loads for any type of driven equipment. In this system, gas and fuel flows are metered to match a map of the limiting fuel energy based GSR (gas fuel energy rate/total fuel energy rate) at all loads for each engine model. Again, some parts of the system of FIG. 8 are identical to those of previous embodiments, and like reference numbers are used as appropriate. The system of FIG. 8 may also include a gas flow bias based on detected acceleration, as illustrated in FIGS. 4 and 7 and described above in connection with those embodiments. This system controls gas flow based on a previously calibrated or average Gas Substitution Ratio versus total fuel energy rate (e.g. Btu/hour), for example as illustrated in FIG. 9. Different maps of Btu/hour versus gas substitution ratio may be generated for different engine models. The total Btu/hour is determined based on the Btu/hour equivalent for the detected gas and diesel fuel flows, and the resultant GSR from FIG. 9 is compared to the detected GSR. The gas flow is then adjusted to correct from any variation in the detected GSR from the mapped GSR for the total Btu/hour for that engine model.

The gas metering assembly 60 in this embodiment is associated with a precise, fast response gas mass flowmeter 62. The current gas flow determined by the gas flowmeter 62 and the diesel flow output from diesel flow meter 65 are inputs to a GSR mapping controller or module 64, which also includes the stored diesel fuel heating value 66 and the gas fuel heating value 68. The total engine Btu/hour for the currently detected gas and diesel flow rates is determined from FIG. 9 and the optimum or mapped GSR for that Btu/hour is determined (command GSR).

The current gas flow reading is then combined in GSR map controller 64 with the diesel flow signal from diesel flow meter 65, which comes from the ECU, CAN bus or an external liquid flow meter, to determine the actual, fuel energy rate based GSR. The corresponding GSR is determined using the gas heating value for the detected gas and diesel flows, and a fuel energy rate(Btu/hour)-based GSR is computed by the formula:

GSR=[gas flow*gas heating value]/[gas flow*gas heating value+diesel flow*diesel heating value]

The GSR value thus derived is subtracted from the command GSR from the engine map of FIG. 9, and the resulting GSR error is used to provide a gas flow command output 69 to modulate metered gas flow. At all times the OEM diesel governor 12 modulates diesel fuel flow to maintain set speed, while the gas metering assembly controls gas flow to maintain GSR at its optimum value. With this scheme, accurate GSR control is maintained regardless of load level. This method also obviates the need for sensing a changing set of load-indicating parameters whenever the type of engine-driven equipment is changed. The system is engine-specific but driven load-independent.

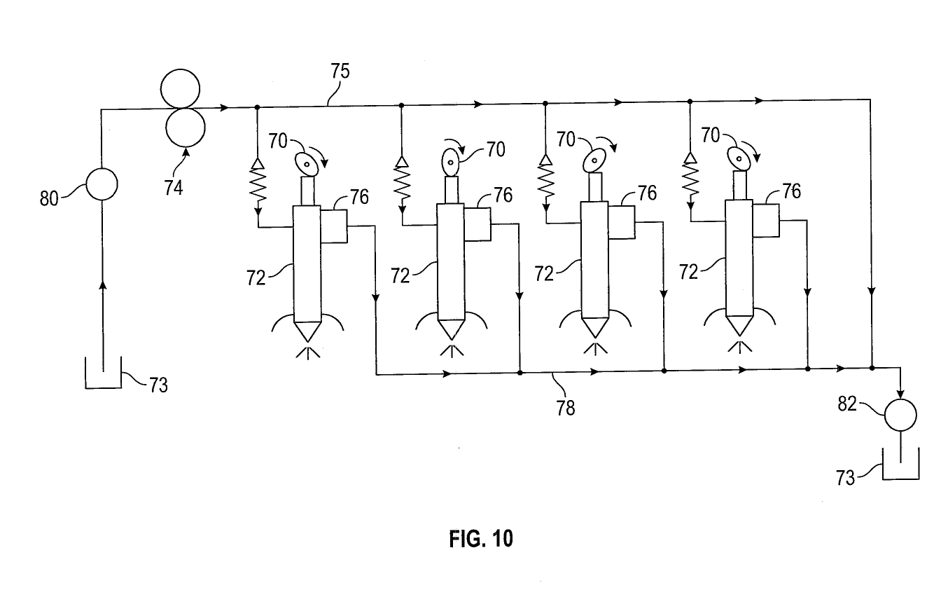

FIG. 10 illustrates a schematic diagram of an alternative system for detecting diesel fuel flow which can be used in place of the diesel flow meter of any of the preceding embodiments to provide a faster indication of variations in diesel fuel flow. In typical “unit injector” diesel fuel systems, an intermittent, cam actuated, high pressure pump 70 is fitted to each injector 72. The fuel is supplied from fuel tank 73 by a low pressure, engine driven pump 74 via a common line 75 to each injector, where it is ported through a normally open solenoid valve 76 to tank return 78. At the injector, the return flow solenoid valve is closed briefly at an injection time determined by the ECU to allow the cam/pump to drive fuel through the injector nozzle into the combustion chamber. For the majority of the time, the solenoids are open and supply-fuel flows freely from the engine driven pump to fuel tank return.

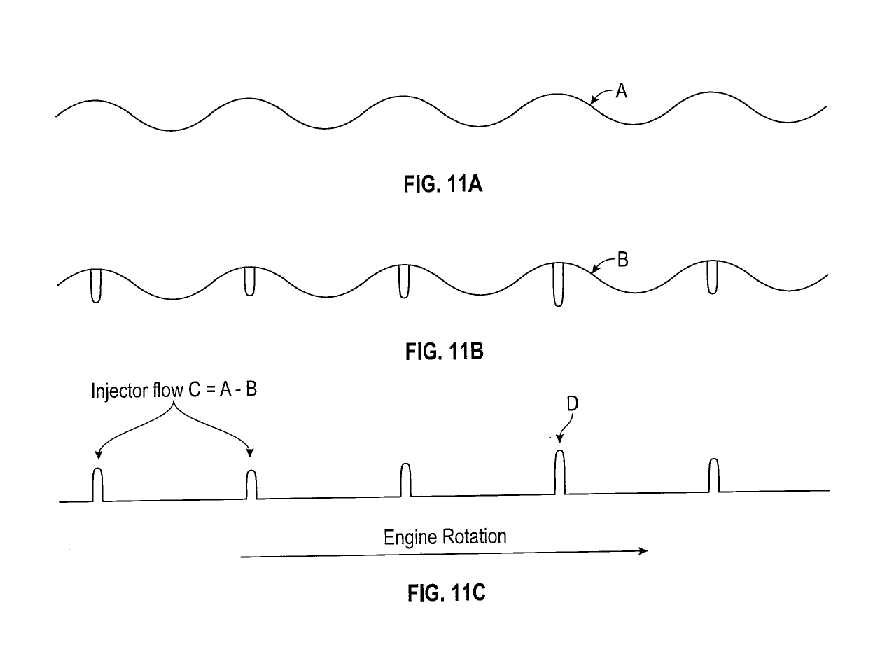

In the system of FIG. 10, a fast response, diesel flow meter assembly measures the difference between supply flow at flow meter 80 and return flow at flow meter 82 to derive injector flows, as illustrated in FIGS. 11A to 11C. The waveform A in FIG. 11A illustrates the supply flow output of meter 80, while the waveform B illustrated in FIG. 11B is the output of return flow meter 82, with dips each time the solenoid valve 76 is closed. Waveform C illustrated in FIG. 11C is the result of subtracting waveform B from waveform A, producing the injector flow. The intermittent flow signal thus derived can be averaged to provide a diesel flow signal for any of the GSR control systems depicted in FIGS. 3, 4, 7 and 8. The advantage here is that average flow sensing response time is on the order of tens of milliseconds, which greatly enhances GSR correction during engine transients in any of the embodiments described above. The larger peak D in FIG. 11C indicates a possible engine misfire.

A further advantage of this scheme is the possibility of looking at individual injector flows in terms of deviations from average flow for diagnostic purposes. For example, an over-rich injector flow signal may be correlated to misfire signals from knock or engine acceleration sensors. Also unbalanced injection flow signals can be used as correlates to performance degradation metrics, such as increased sfc, vibration, etc. When sensing individual flows, the flow meter response will be on the order of 1-3 msec. FIGS. 11A to 11C present typical wave forms of the flow meter signals. While FIG. 10 shows this scheme applied to a “unit injector” diesel fuel system, the high speed diesel flowmeter concept can be applied equally well in any other injector system, such as common-rail direct injection, etc.

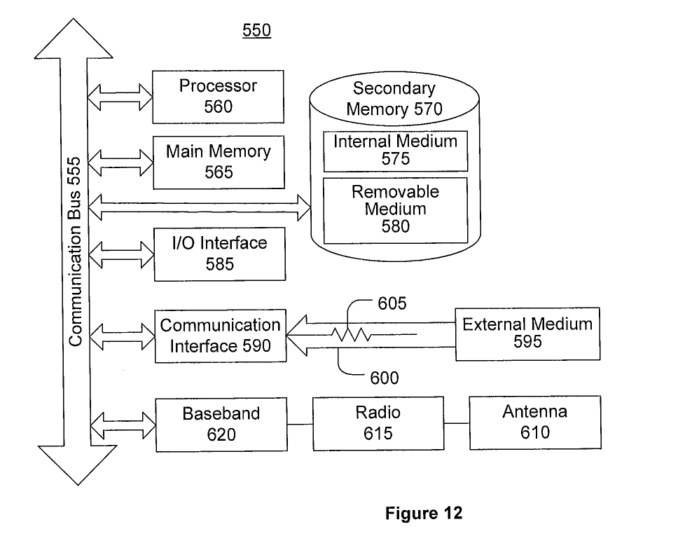

FIG. 12 is a block diagram illustrating an example of a computer system 550 that may be used in connection with various embodiments described herein. For example, the computer system 550 may be used as a microprocessor or central processing unit which performs the functions of the modules illustrated and described above in connection with the systems of FIG. 3, 4, 7 or 8. However, other computer systems and/or architectures may be used, as will be clear to those skilled in the art.

The computer system 550 preferably includes one or more processors, such as processor 560. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 560.

The processor 560 is preferably connected to a communication bus 555. The communication bus 555 may include a data channel for facilitating information transfer between storage and other peripheral components of the computer system 550. The communication bus 555 further may provide a set of signals used for communication with the processor 560, including a data bus, address bus, and control bus (not shown). The communication bus 555 (as well as the CAN bus illustrated in the embodiment of FIG. 7, and other communication buses which may be used in any of the above embodiments) may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPIB”), IEEE 696/S-100, and the like.

Computer system 550 preferably includes a main memory 565 and may also include a secondary memory 570. The main memory 565 provides storage of instructions and data in a computer readable medium for programs executing on the processor 560. The main memory 556 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 570 may optionally include a hard disk drive which has an internal storage medium (hard disk) 575 and/or a removable storage drive for receiving a removable storage medium 580, for example a floppy disk drive, a magnetic tape drive, a compact disc (“CD”) drive, a digital versatile disc (“DVD”) drive, etc. The removable storage drive reads from and/or writes to removable storage medium 580 in a well-known manner. Removable storage medium 580 may be, for example, a floppy disk, magnetic tape, CD, DVD, etc.

The removable storage medium 580 is a non-transitory computer readable medium having stored thereon computer executable code (i.e., software) and/or data. The computer software or data stored on the removable storage medium 580 is read into the computer system 550 as electrical communication signals for execution by the processor.

In alternative embodiments, secondary memory 570 may include other similar means for allowing computer programs or other data or instructions to be loaded into the computer system 550. Such means may include, for example, an external storage medium and interface 585. Examples of an external storage medium may include an external hard disk drive or an external optical drive, or an external magneto-optical drive.

Other examples of secondary memory 570 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are any other removable storage units and interfaces, which allow software and data to be transferred from the removable storage unit to the computer system 550.

Computer system 550 may also include a communication interface 590. The communication interface 590 allows software and data to be transferred between computer system 550 and external devices 610 (e.g. printers, external storage media), networks, or information sources. For example, computer software or executable code may be transferred to computer system 550 from a network server via communication interface 590. Examples of communication interface 590 include a modem, a network interface card (“NIC”), a communications port, a PCMCIA slot and card, an infrared interface, and an IEEE 1394 fire-wire, just to name a few. Communication interface may also comprise Bluetooth or other wireless communication interface.

Communication interface 590 preferably implements industry promulgated protocol standards, such as Ethernet IEEE 802 standards, Fibre Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via communication interface 590 are generally in the form of electrical communication signals 605. These signals 605 are preferably provided to communication interface 590 via a communication channel 600. Communication channel 600 carries signals 605 and can be implemented using a variety of wired or wireless communication means including wire or cable, fiber optics, conventional phone line, cellular phone link, wireless data communication link, radio frequency (“RF”) link, or infrared link, just to name a few.

Computer executable code (i.e., computer programs or software) is stored in the main memory 565 and/or the secondary memory 570. Computer programs can also be received via communication interface 590 and stored in the main memory 565 and/or the secondary memory 570. Such computer programs, when executed, enable the computer system 550 to perform the various functions of the embodiments described above.

In this description, the term “computer readable medium” is used to refer to any non-transitory computer readable storage media used to provide computer executable code (e.g., software and computer programs) to the computer system 550. Examples of these media include main memory 565, secondary memory 570 (including hard disk drive), removable storage medium 580, and external storage medium 610, and any peripheral device communicatively coupled with communication interface 590 (including a network information server or other network device). These non-transitory computer readable mediums are means for providing executable code, programming instructions, and software to the computer system 550.

In an embodiment that is implemented using software, the software may be stored on a computer readable medium and loaded into computer system 550 by way of the removable storage drive, interface 585, or communication interface 590. In such an embodiment, the software is loaded into the computer system 550 in the form of electrical communication signals 605. The software, when executed by the processor 560, preferably causes the processor 560 to perform the features and functions previously described herein.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

The system 550 also includes optional wireless communication components that facilitate wireless communication over a voice and over a data network. The wireless communication components comprise an antenna system 610, a radio system 615 and a baseband system 620. In the communication device 550, radio frequency (“RF”) signals are transmitted and received over the air by the antenna system 610 under the management of the radio system 615.

In one embodiment, the antenna system 610 may comprise one or more antennae and one or more multiplexors (not shown) that perform a switching function to provide the antenna system 610 with transmit and receive signal paths. In the receive path, received RF signals can be coupled from a multiplexor to a low noise amplifier (not shown) that amplifies the received RF signal and sends the amplified signal to the radio system 615.

In alternative embodiments, the radio system 615 may comprise one or more radios that are configured to communication over various frequencies. In one embodiment, the radio system 615 may combine a demodulator (not shown) and modulator (not shown) in one integrated circuit (“IC”). The demodulator and modulator can also be separate components. In the incoming path, the demodulator strips away the RF carrier signal leaving a baseband receive audio signal, which is sent from the radio system 615 to the baseband system 620.

If the received signal contains audio information, then baseband system 620 decodes the signal and converts it to an analog signal. Then the signal is amplified and sent to a speaker. The baseband system 620 also receives analog audio signals from a microphone. These analog audio signals are converted to digital signals and encoded by the baseband system 620. The baseband system 620 also codes the digital signals for transmission and generates a baseband transmit audio signal that is routed to the modulator portion of the radio system 615. The modulator mixes the baseband transmit audio signal with an RF carrier signal generating an RF transmit signal that is routed to the antenna system and may pass through a power amplifier (not shown). The power amplifier amplifies the RF transmit signal and routes it to the antenna system 610 where the signal is switched to the antenna port for transmission. The baseband system 620 is also communicatively coupled with the processor 560. The central processing unit 560 has access to data storage areas 565 and 570. The central processing unit 560 is preferably configured to execute instructions (i.e., computer programs or software) that can be stored in the memory 565 or the secondary memory 570. Computer programs can also be received from the baseband processor 620 and stored in the data storage area 565 or in secondary memory, or executed upon receipt. Such computer programs, when executed, enable the communication device 550 to perform the various functions of the present invention as previously described. For example, data storage areas 565 may include various software modules (not shown) that perform the various functions of the present invention as previously described.

Those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, and methods described in connection with the embodiments disclosed herein can be implemented or performed with a general purpose processor, a digital signal processor (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly limited by nothing other than the appended claims.

We claim:

1. A method of controlling gas substitution ratio in a bi-fuel engine, comprising:
calibrating a bi-fuel engine having a gaseous fuel input and a non-gaseous fuel input over a range of engine loads to determine the gaseous fuel flow and corresponding non-gaseous fuel flow to produce predetermined gas substitution ratios (GSR) over the calibrated load range;
storing the calibration data in a data base;
detecting current non-gaseous fuel flow to the engine;
using the stored calibration data to determine the gaseous fuel flow corresponding to the current detected non-gaseous fuel flow;
controlling a gas metering assembly to produce a gaseous fuel flow to the engine corresponding to the determined gaseous fuel flow computed from the stored calibration data; and
continuing to monitor the current non-gaseous fuel flow to the engine and adjusting the gaseous fuel flow in response to variations in detected non-gaseous fuel flow in order to maintain the GSR at or close to the predetermined level and compensate for variations in detected non-gaseous fuel flow.

2. The method of claim 1, wherein the non-gaseous fuel is diesel (DF) and the gaseous fuel is natural gas (NG).

3. The method of claim 1, wherein the non-gaseous fuel is diesel (DF) and the gaseous fuel is propane.

4. The method of claim 1, wherein gaseous fuel flow to the engine is adjusted by controlling the gaseous fuel pressure to the engine.

5. The method of claim 1, further comprising detecting increase in acceleration of the engine and determining a gas flow bias based on the detected increase in acceleration, and controlling the gas metering assembly to reduce the gaseous fuel flow by the determined gas flow bias.

6. The method of claim 1, wherein the step of detecting non-gaseous fuel flow to the engine comprises detecting a supply flow A of non-gaseous fuel to a non-gaseous fuel injector, detecting a return flow B of non-gaseous fuel from the injector, and determining non-gaseous fuel flow to the engine by subtracting return flow B from supply flow A.

7. The method of claim 6, wherein the method of detecting supply flow A of non-gaseous fuel to a non-gaseous fuel injector and the method of detecting a return flow B of non-gaseous fuel from the injector are at predetermined speeds sufficient to measure the flow for each injector.

8. The method of claim 1, wherein the step of detecting non-gaseous fuel flow to the engine comprises reading the fuel flow parameter from the electronic control unit (ECU) of the engine.

9. A method of controlling gas substitution ratio in a bi-fuel engine, comprising:
calibrating a bi-fuel engine having a gaseous fuel input and a non-gaseous fuel input by monitoring the non-gaseous fuel input while running the bi-fuel engine at full load and increasing gaseous fuel flow to the bi-fuel engine until an engine misfire is detected;
selecting a minimum non-gaseous fuel flow set point which exceeds the non-gaseous fuel flow corresponding to the engine misfire;
storing the selected minimum non-gaseous fuel flow set point in a data base;
detecting non-gaseous fuel flow rate to the engine during normal operation;
comparing the detected current non-gaseous fuel flow rate to the minimum non-gaseous fuel flow set point;
controlling a gas metering assembly to vary the gaseous fuel flow to the engine until the non-gaseous fuel flow to the engine corresponds to the minimum non-gaseous fuel flow set point; and
continuing to monitor the current non-gaseous fuel flow to the engine and adjusting the gaseous fuel flow rate in response to variations in detected non-gaseous fuel flow from the selected minimum non-gaseous fuel flow set point in order to maintain the non-gaseous fuel flow rate at or close to the selected minimum non-gaseous fuel flow set point.

10. The method of claim 9, wherein the non-gaseous fuel is diesel and the gaseous fuel is natural gas.

11. The method of claim 9, wherein the non-gaseous fuel is diesel (DF) and the gaseous fuel is propane.

12. The method of claim 9, wherein gaseous fuel flow to the engine is adjusted by controlling the gaseous fuel pressure to the engine.

13. The method of claim 9, further comprising detecting increase in acceleration of the engine and determining a gas flow bias based on the detected increase in acceleration, and controlling the gas metering assembly to reduce the gaseous fuel flow by the determined gas flow bias.

14. The method of claim 9, further comprising selecting a predetermined cut off non-gaseous fuel flow set point corresponding to a minimum idle flow setting, and cutting off gaseous fuel flow to the engine when the adjusted gaseous fuel flow output corresponds to a non-gaseous fuel flow rate below the cut off non-gaseous fuel flow set point.

15. The method of claim 14, wherein the predetermined cut off non-gaseous fuel flow set point is between minimum idle flow and the selected minimum non-gaseous fuel flow set point.

16. The method of claim 9, wherein the step of detecting non-gaseous fuel flow to the engine comprises detecting a supply flow A of non-gaseous fuel to a non-gaseous fuel injector, detecting a return flow B of non-gaseous fuel from the injector, and determining non-gaseous fuel flow to the engine by subtracting return flow B from supply flow A.

17. The method of claim 9, wherein the step of detecting non-gaseous fuel flow to the engine comprises reading the fuel flow parameter from the engine's electronic control unit (ECU).

18. A method of controlling gas substitution ratio in a bi-fuel engine, comprising:
calibrating a bi-fuel engine having a gaseous fuel input and a non-gaseous fuel input at different loads to determine the gaseous fuel flow and corresponding non-gaseous fuel flow at varying engine loads to calibrate a command gaseous fuel substitution ratio (GSR) based on fuel energy at varying engine loads for the bi-fuel engine;
mapping total fuel energy rate (gas fuel energy rate/total fuel energy rate) against the calibrated GSR to create GSR mapping data;
storing the GSR mapping data in a data base;
detecting current gaseous fuel flow rate and non-gaseous fuel flow rate to the engine;
determining the fuel energy rate corresponding to the current detected gaseous and non-gaseous fuel flow rates;
using the stored GSR mapping data to determine a command GSR corresponding to the currently detected gaseous and non-gaseous fuel flow rate;
determining the actual GSR from the currently detected gaseous and non-gaseous fuel flow rates;
comparing the current GSR to the command GSR; and
varying the gas flow to the engine in response to detected differences between the current GSR and the command GSR to adjust the actual GSR to be at or close to the desired command GSR.

19. The method of claim 18, wherein the non-gaseous fuel is diesel and the gaseous fuel is natural gas.

20. The method of claim 18, wherein the non-gaseous fuel is diesel (DF) and the gaseous fuel is propane.

21. The method of claim 18, wherein gaseous fuel flow to the engine is adjusted by controlling the gaseous fuel pressure to the engine.

22. The method of claim 18, further comprising detecting increase in acceleration of the engine and determining a gas flow bias based on the detected increase in acceleration, and controlling the gas metering assembly to reduce the gaseous fuel flow by the determined gas flow bias.

23. The method of claim 18, wherein the step of detecting non-gaseous fuel flow to the engine comprises detecting a supply flow A of non-gaseous fuel to a non-gaseous fuel injector, detecting a return flow B of non-gaseous fuel from the injector, and determining non-gaseous fuel flow to the engine by subtracting return flow B from supply flow A.

24. The method of claim 18, wherein the step of detecting non-gaseous fuel flow to the engine comprises reading the fuel flow parameter from the engine's electronic control unit (ECU).

25. A gas substitution control system for a bi-fuel engine having a gaseous and a non-gaseous fuel input, comprising:
a gaseous fuel input assembly connected to a gaseous fuel input of a bi-fuel engine and a non-gaseous fuel injector assembly connected to a non-gaseous fuel input of the bi-fuel engine;
a non-gaseous fuel flow detector module configured to detect non-gaseous fuel flow to the engine and produce a non-gaseous fuel flow output;
a gaseous fuel flow control module communicating with the non-gaseous fuel flow output of the non-gaseous fuel flow detector module and configured to vary gaseous fuel flow to the engine based on at least a current non-gaseous fuel flow output of the non-gaseous fuel flow detector module.

26. The gas substitution control system of claim 25, wherein the gaseous fuel flow control module further comprises a data storage unit having stored calibration data for the bi-fuel engine, and the gaseous fuel control module is programmed to vary gaseous fuel flow to the engine based on the stored calibration data in addition to the detected current non-gaseous fuel flow to the engine.

27. The gas substitution control system of claim 26, wherein the stored calibration data comprises a range of non-gaseous fuel flow rates and corresponding gaseous fuel flow rates providing predetermined gas substitution ratios (GSR) of gaseous fuel flow to total gaseous and non-gaseous fuel flows over a range of engine loads, and the gaseous fuel flow control module is configured to look up the calibrated gaseous fuel flow rate corresponding to the current detected non-gaseous fuel flow rate in the stored calibration data and to adjust the gaseous fuel flow rate based on the stored gaseous fuel flow rate corresponding to the detected non-gaseous fuel flow rate.

28. The gas substitution control system of claim 27, further comprising an acceleration detection module configured to detect acceleration of the engine as a result of decreased engine load and to produce an acceleration output signal, a gaseous fuel flow bias module having an input which receives the acceleration output signal and produces an output comprising a gas flow bias amount dependent on the acceleration output signal, and a comparator module connected to the outputs of the gaseous fuel flow control module and the gaseous fuel flow bias module and configured to reduce the adjusted gaseous fuel flow rate by the gas flow bias amount.

29. The gas substitution control system of claim 25, further comprising a comparator configured to compare the output of the non-gaseous fuel flow detector module with a predetermined minimum non-gaseous fuel flow set point, the gaseous fuel flow control module further comprising an integrating module which is programmed to adjust the gaseous fuel flow rate based on the output of the comparator such that the non-gaseous fuel flow is adjusted to be at least substantially equal to the predetermined minimum non-gaseous fuel flow set point, whereby the gas substitution amount is based on the predetermined minimum non-gaseous fuel flow set point.

30. The gas substitution control system of claim 29, further comprising a gaseous fuel flow cut off control module programmed to shut off gaseous fuel flow to the engine if the detected non-gaseous fuel flow is below a predetermined minimum idle non-gaseous fuel flow set point.

31. The gas substitution control system of claim 25, wherein the gaseous fuel flow control module further comprises a data base containing stored calibration data comprising a map of total fuel energy rate versus gas substitution ratios (command GSRs) over a range of engine loads, the gaseous fuel flow control module being programmed to compute a current total fuel energy rate and gas substitution ratio based on current detected gaseous and non-gaseous fuel flow rates, to determine the mapped command GSR corresponding to the current total fuel energy rate, to compare the computed current GSR with the mapped command GSR in order to produce a GSR error, and to vary the gaseous fuel flow based on the current GSR error in order to control the GSR to be at or close to the command GSR corresponding to the current total fuel energy rate.

32. The gas substitution control system of claim 25, wherein the non-gaseous fuel flow injector assembly comprises at least one non-gaseous fuel injector having an injector nozzle communicating with an engine combustion chamber, a non-gaseous fuel flow supply path to at least one non-gaseous fuel flow injector, and a non-gaseous fuel return path from the non-gaseous fuel injector for return of non-gaseous fuel to a fuel tank when non-gaseous fuel is not being injected into the engine combustion chamber, the non-gaseous fuel flow detector module comprising a supply flow meter in the non-gaseous fuel flow supply path for detecting non-gaseous fuel flow to the non-gaseous fuel injector, a non-gaseous fuel return flow meter in the non-gaseous fuel return path, and a comparator module configured to subtract the output of the non-gaseous fuel return flow meter from the output of the fuel supply flow meter to produce a non-gaseous fuel flow output corresponding to the non-gaseous fuel flow input from the at least one non-gaseous fuel injector to the engine combustion chamber.

33. The gas substitution control system of claim 25, wherein the gaseous fuel flow control module is configured to vary gaseous fuel flow to the engine by controlling the gaseous fuel pressure.
